(19) United States
(12) Patent Application Publication
(10) Pub. No.: US 2006/0184713 A1
(43) Pub. Date: Aug. 17, 2006

(54) Method for operating a virtual machine computer system running guest operating systems on a central processing means virtualized by a host system having register stack engine functionality

(75) Inventor: Christian Hildner, Nurnberg (DE)

Correspondence Address: BROWDY AND NEIMARK, P.L.L.C.;624 NINTH STREET, NW, SUITE 300, WASHINGTON, DC, 20001-5303, US

(73) Assignee: HOB GmbH & Co. KG, Cadolzburg (DE)

(21) Appl. No.: 11/058,312

(22) Filed: Feb. 16, 2005

(51) Int. Cl. G06F 12/00

(52) U.S. Cl. 711/6

(57) ABSTRACT

A method for operating a virtual machine computer system running computer guest operating system processes on a central processing means in a virtualized manner includes the steps of checking the virtual TLB entry for the backing store address of the register stack engine (RSE) by the VMM and in case there is no valid TLB entry calling the guest interrupt handler, inserting valid TLB entry for the backing store address, returning to VMM, calling and proceeding with guest process.

### BACKGROUND OF THE INVENTION

1. Field of the Invention:

The invention relates to a method for operating a virtual machine computer system being capable of running multiple guest operating systems concurrently by virtualization of a host machine. In this connection commonly operating systems of several guests are handled on the hardware of the host machine under the host operating system by means of a so-called virtual machine monitor.

### BACKGROUND ART

A computer system generally consists of input/output devices, memory devices and a central processing unit (CPU). In the CPU a memory management unit (MMU) is implemented which in the context of host/guest systems uses the principle of virtual addressing. Actually all current operating systems installed and running on standard CPUs use this principle of virtual addressing to protect the memory of different processes against accesses from outside of the currently running process.

To make use of the virtual addressing facility the MMU has to have a knowledge of both the virtual addresses and the corresponding physical addresses involved in a process, i.e. the MMU disposes of a reference list with a “translation” between each virtual address and each corresponding physical address. One of these translations is always valid for a whole memory area—a so called “memory page”.

The part of the MMU which contains said translations is called translation look-aside buffer (TLB). In this connection CPUs use a mechanism called “software managed TLB” or additionally a hardware page table walker to support these translations. The TLB typically contains a number of entries each of which can be filled with the translation for a particular memory page.

Now if a program wants to access a memory location using a virtual address and there is no valid TLB entry present for that address the CPU interrupts the program flow and gives control to the operating system to enable it to insert said missing entry into the TLB. Inasmuch the operating system is responsible for all entries in the TLB to be correct and up to date.

To visualize the entries and use of the TLB reference is made to the accompanying drawing of FIG. 1 which shows a system block diagram of a virtual machine system realized by a host computer 3 on which two guest operating systems 1, 2 are to be run in a virtualized computer environment. The host computer 3 commonly comprises a central processing unit (CPU) 8 in which a memory management unit (MMU) 9 already cited above is implemented. Further on the host computer 3 comprises a memory unit with common read-only- and random-access-memories (ROM's and RAM's) cooperating with the CPU 8. The memory unit is mapped into the physical address space 15.

Now as can be seen from FIG. 1 the MMU 9 handles the virtual address spaces 11, 12 of two processes #1 and #2 of the virtualized systems 1 and 2, respectively. Within these virtual address spaces 11, 12 the virtual addresses 111, 112 of the processes # 1 and #2 are contained.

In the above mentioned translation look-aside buffer (TLB) 13 of the MMU 9 one can find a number of entries 14.1, 14.2, each of which is filled with a translation for a particular memory page, e.g. for process #1 the entry 14.1 comprises the virtual address 111 and the according physical address 211. Accordingly entry 14.2 comprises the virtual address 112 of the virtual address space 12 of process #2 and the according physical address 212. The same applies for all entries 14n with the n-th entry comprising a virtual address 11n and a physical address 21n. The physical addresses 211, 212, . . . 21n point to the physical address space 15.

A further functionality of the CPU 8 is the so-called register stack engine (RSE) 20, which is working “in the background” of the CPU 8 and cooperating with part of a set of general registers 25. These are to be described as memory cells with a fixed size, e.g. 32 bits or 64 bits and can include static registers 25.1 and stacked registers 25.2. Different units of the CPU 8 can do operations on these registers. The RSE 20 working on the stacked registers 25.2 moves the contents of these registers between the registers and the backing store in memory without explicit program intervention.

Modern CPUs 8 contain a mechanism that allows a view only on part of the stacked registers 25.2 which is the so-called register window or frame 27. Now the stacked registers 25.2 can be saved to memory or restored therefrom by the RSE 20 contained in the CPU 8 in an independent manner, whereby the CPU is allowed to save/restore all stacked registers 25.2 except that of the currently active register frame or window 27.

As concerns e.g. the Intel® IA-64 architecture the RSE functionality is disclosed in the “Intel® IA-64 Architecture Software Developer's Manual”, Volume 2: IA-64 System Architecture, revision 1.1, July 2000, (in the following shortly “Intel® IA-64 Manual”) page 6-1 to 6-5 with an overlook of the system register model of the processor on FIG. 3-5.

Realizing aforesaid memory operations the CPU 8 typically uses virtual addressing, leading to the need for an according mapping by a valid TLB entry 11/14. In case there is no valid TLB entry present for a memory location the CPU instead of interrupting the program flow immediately delays interruption until one of a set of triggering instructions are executed. Said triggering instructions are a distinct subset of RSE related instructions which themselves are a subset of the whole instruction set of a processor.

As an example the Intel® IA-64 architecture knows following triggering instructions which are listed in the Intel® IA-64 Manual, page 6-11: alloc, br.ret, rfi, flushrs, loadrs, or mov to/from BSP, BSPSTORE, RSC, PFS, IFS, or RNAT.

The problem underlying the present invention is complex and therefore needs detailed reflection before turning to the core of the invention. This is done by the second drawing FIG. 2 showing a chronological scheme of operating a virtual machine computer system in the virtual machine monitor and in normal guest code.

Point of origin is the computer system with the processor executing in the virtual machine monitor VMM (block 30).

Within this mode no RSE operations should occur, as commonly the virtual machine monitor is programmed without according instructions, i.e. the virtual machine code has not RSE functionality (block 32).

Now by the above mentioned RSE instruction the process is switched from virtual machine monitor to normal guest code (block 34).

In case the processor executes in normal guest code (block 36), commonly all registers are used by the guest operating system including its kernel and guest applications. Thus a conflict with the RSE can arise with the RSE operation faulting (block 38).

As already stated above while working in the normal guest code in this case the interruption is delayed until one of the above mentioned triggering, register stack-related instructions “alloc, br.ret, rfi, . . . ” arises (block 40). In this instance an interrupt is generated which switches the processor from normal guest code to the virtual machine monitor which manages the according interrupt by its interrupt handler. Aforesaid interruption further resets the so-called RSE.CFLE bit (see “Intel®IA-64 Manual” page 6-12). This allows the VMM interruption handler to handle the fault raised by the abovesaid RSE operation.

The faulting RSE operation is raised by a faulty, e.g. incomplete TLB (block 42). The virtual machine monitor checks in the following query (block 44) whether a valid virtualized TLB entry is available, according to which the VMM interrupt handler can construct a real hardware TLB entry.

If this is true (branch Y) the virtual machine monitor constructs this real TLB entry (block 46), inserts same into the TLB (block 48) and gives the return from interruption—rfi—instruction (block 50). Thus the processor is switched from the virtual machine monitor mode into normal guest code.

The rfi instruction (block 50) further sets the RSE.CFLE flag to 1 which enables the RSE to restore registers for the current frame of the target instruction. As this is possible due to the valid TLB entry, the according RSE operation is successful (block 52). This means that the execution of normal guest code can be continued in undisturbed manner (block 54).

The problem underlying this invention arises when in query 44 no valid virtualized TLB entry is available. Continuing with branch N the VMM is faulty as concerns construction of such virtual TLB entry (block 60) and therefore the VMM interrupt handler has to construct a virtualized interrupt and call the guest interrupt handler. For this reason the VMM again has to use the rfi instruction to make this switch over from VMM to guest code (block 62). This, however, means that the RSE.CFLE flag is set to 1 and the RSE is therefore newly trying to make the intended RSE operation. Because of the still missing or invalid TLB entry this again will fail leading to an endless loop as the process is in a state “TLB faults” (block 42) again. This means that in the query 44 the yes-branch “Y” is never reached and the process cycles in the endless loop of blocks 42, 44, 60, 62 and 64. Thus the guest interrupt handler (block 66) is never reached.

### SUMMARY OF THE INVENTION

Starting from the aforementioned problem of the prior art the object of the invention is to provide a method for operating a virtual machine computer system running guest operating system processes on a central processing means fully virtualized by the VMM avoiding an undefined state of the TLB entry for the register stack engine ensuring that the system is not trapped in above explained endless loop.

This object is achieved by the operating steps of checking the virtual TLB entry for a specific memory location of the RSE by the VMM before calling a guest process in the system and only calling and proceeding with the guest process in case there is a valid virtual TLB entry existent.

In case there is no valid TLB entry the guest interrupt handler is called, which inserts a valid TLB entry for the specific memory location of the RSE and returns the process to VMM to call and proceed with the guest process.

By aforesaid method steps the reason for the endless loop when running the processor in the discussed prior art way is avoided principally, as the system takes care for defining a valid virtual TLB entry for the RSE before the RSE accesses a TLB with missing or invalid TLB entries.

According to a preferred embodiment of the invention the specific memory location where the RSE operates on, is read from a backing store address application register. According to the Intel® IA-64 architecture this backing store address (BSPSTORE) application register contains the address at which the next RSE spill will occur. (see Intel® IA-64 Manual, page 6-1).

According to a further preferred embodiment the check for a valid virtual TLB entry is only perfonned while processing emulated guest return from interrupt—rfi—instructions.

The further preferred embodiment refers to a specific system feature, the so-called virtual hash page table VHPT. This is an extension of the TLB hierarchy designed to enhance virtual address translation performance. Full disclosure of the function is given in Intel® IA-64 Manual, para. 4.1.5 starting on page 4-14. In case the VHPT is enabled, instead of the specific memory location of the RSE backing store, its according address inside the VHPT is checked to be in the virtual TLB.

Further features, details and advantages of the invention are disclosed in the following description in which an embodiment of the subject matter of the invention is described in more detail with reference to the accompanying drawings.

### BRIEF DESCRIPTION OF THE DRAWINGS

FIG. 1 is a block diagram of a virtual machine system,

FIG. 2 is a chronological scheme of a prior art process running on a virtual machine system, and

FIG. 3 is a chronological scheme of a process according to the invention running on said virtual machine system.

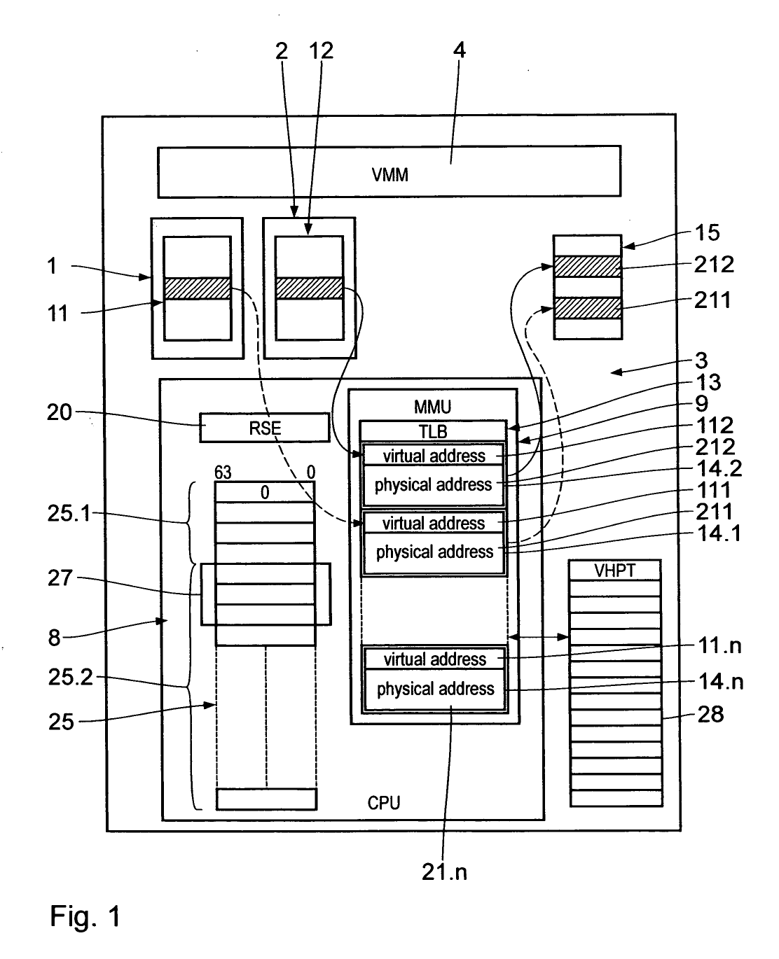

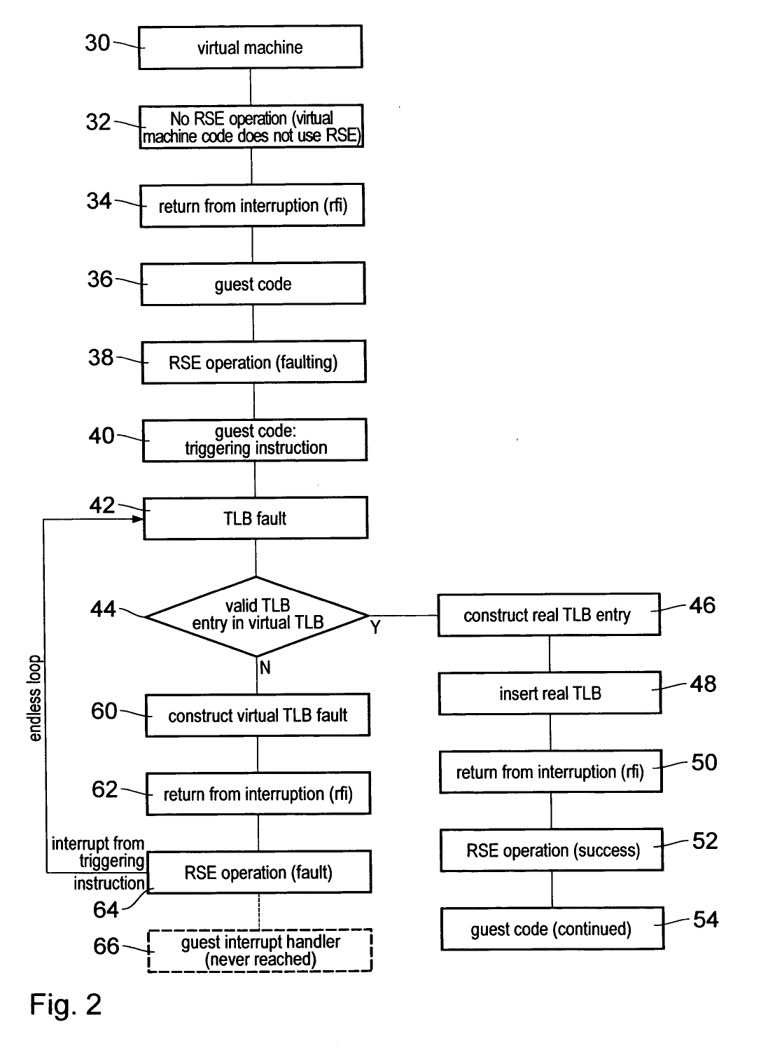

As concerns the description of FIGS. 1 and 2 reference is made to the according annotations above discussing the background of the invention.

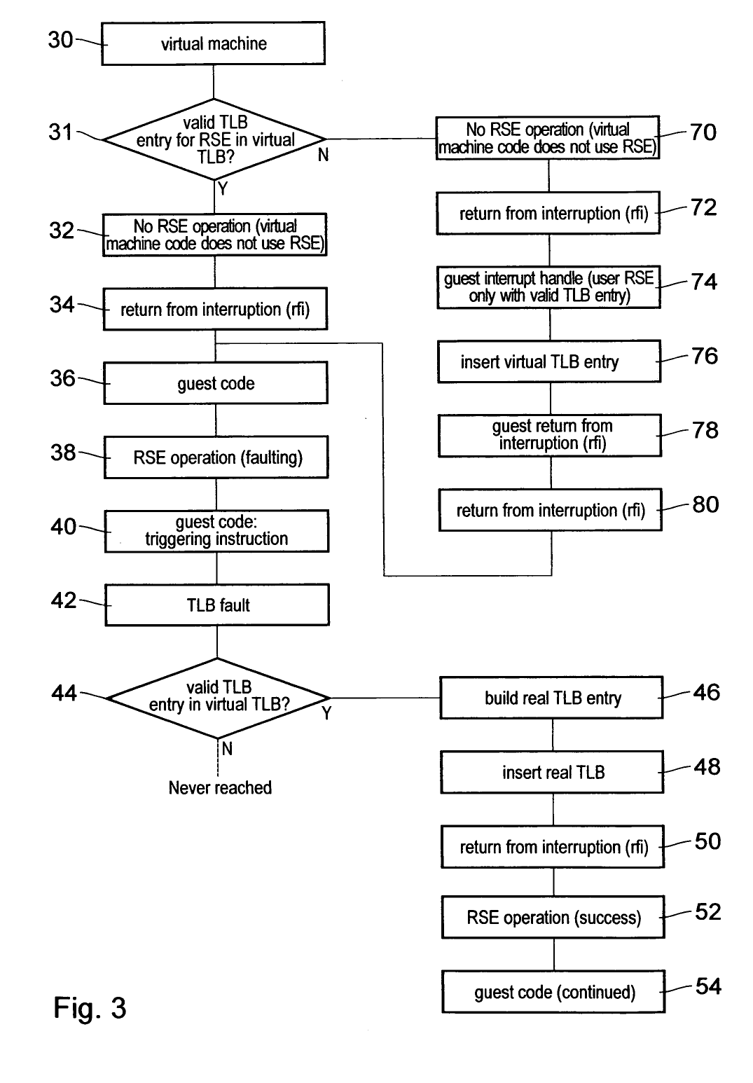

Now as concerns the present invention reference is made to FIG. 3 in which the blocks exemplifying the same process steps as they are explained in connection with FIG. 2 are indicated with identical reference numerals. Inasmuch it is not necessary to repeat any according explanations which can be fully derived from the description of FIG. 2.

However, as additional method step between blocks 30 and 32 representing the regular state of the virtual machine monitor before calling guest code a query 31 is inserted, which checks the virtual TLB entry for a specific memory location, i.e. the backing store address BSPSTORE of the register stack RSE engine 20 by the virtual machine monitor VMM 4. In case there is a valid TLB entry the process proceeds with branch Y and the blocks 32, 34, 36, 38, 40, 42, 44, 46, 48, 50, 52 and 54 as explained in connection with FIG. 2. The reason is that in the query 44 the no-branch N can never be reached as a valid virtual TLB entry is available.

In case that the query 31 leads to the result that no valid TLB entry is available for the RSE in the virtual TLB the process proceeds with the no-branch N and remains in the virtual machine monitor, where no RSE operations are made, as virtual machine code does not use RSE (block 70). By a return from interruption—rfi—instruction (block 72) the VMM continues guest operation in the guest interrupt handler (block 74). The latter can insert a virtualized TLB entry for the requested backing store address in a safe way, as the virtual interrupt is given to the guest before it could eventually occur (block 76). This is emulated by the VMM.

To avoid the problem that the virtualized TLB entry is flushed inadvertently by an unforeseeable action of the system leading back to the problem that no valid TLB entry is available in step 44 the virtual TLB entry is internally treated somewhat privileged. Namely such virtual TLB entries are handled to stay resistent in the TLB until they are explicitly flushed by the guest operating system. For this sake the virtual data TLB 13 is divided into two parts, one for regular entries and one for backing store TLB entries. By this way a removal of TLB entries needed by the RSE is avoided. Such the RSE part of the TLB 13 is only flushed by explicit TLB flushes of the guest operating system.

As a next step 78 the guest interrupt handler provides for a return from interruption—rfi—instruction which is also emulated by the virtual machine monitor (block 78).

The return from this no-branch N of the query 31 is provided for by a return from interruption—rfi—instruction 80 by which the guest code is called. Thus the process proceeds with block 36 till block 54 as explained above.

As concerns the query 31 attention is drawn to the fact that the check for a valid virtual TLB entry may only be performed while processing emulated guest—rfi—instructions.

Turning back to FIG. 1 an alternative to checking the specific memory location of the RSE backing store address is to be explained in case that the functionality of the so-called virtual hash page table VHPT 28 is enabled. The VHPT 28 resides in the virtual memory space and is configurable as either the primary page table of the operating system or—as is depicted in FIG. 1—as a single large translation cash in the memory. Since the VHPT 28 resides in the virtual address space an additional TLB miss can be raised when the VHPT 28 is referenced. Inasmuch it makes sense within query 31 to check the VHPT as to an according valid virtual TLB entry.

What is claimed is:

1. A method for operating a virtual machine computer system running computer guest operating system processes on a central processing means in a virtualized manner, said system comprising
a host central processing unit—host CPU (8)—,
a host memory management unit—host MMU (9)—implemented in the host CPU (8) and managing translation look-aside buffers—TLBs (13)—for guest processes, said TLB each comprising memory address entries,
a virtual machine monitor—VMM (4)—for controlling and handling concurrently running guest processes (#1, #2),
a register stack engine functionality—RSE (20)—of the host CPU (8) working on a specific memory location,
a guest interrupt handler managing interruptions in guest processes, said operating method comprising the steps of
before calling a guest process checking the virtual TLB entry for the specific memory location of the RSE by the VMM,
in case there is a valid virtual TLB entry for the specific memory location calling and proceeding with guest process or,
in case there is no valid TLB entry calling the guest interrupt handler,
said guest interrupt handler inserting valid TLB entry for the specific memory location, and,
said guest interrupt handler calling and proceeding with requested guest process.

2. An operating method according to claim 1, wherein the specific memory location where the RSE operates on, is read from a BSPSTORE application register.

3. An operating method according to claim 1, wherein the check for valid virtual TLB entry is only performed while processing emulated guest rfi instructions.

4. An operating method according to claim 1, wherein, when the virtual hash page table (VHPT) is enabled, instead of the specific memory location of the RSE backing store address its according address inside the VHPT (28) is checked to be in the virtual TLB.

5. An operating method according to claim 1, wherein an RSE related TLB entry is kept resistant in the virtual TLB until being explicitly flushed by the guest operating system.
